(19) United States
(12) Patent Application Publication
(10) Pub. No.: US 2012/0009552 A1
(43) Pub. Date: Jan. 12, 2012

(54) ANGER TRAINING CARD GAME

(76) Inventor: Vera Jarrett-McKinney, Los Angeles, CA (US)

(21) Appl. No.: 12/832,589

(22) Filed: Jul. 8, 2010

(51) Int. Cl. G09B 19/22; G09B 19/00

(52) U.S. Cl. 434/129; 434/236

(57) ABSTRACT

A method for playing a card game where players can practice expressing feelings of anger. A hand of letter cards is dwelt to players playing the game. A stack of topic cards is provided from which each player may draw. Each topic card includes an anger topic describing a situation commonly known to cause anger in the average person. A stack of letter cards is also provided. The player selects a topic card from the stack of topic cards. The player then verbalizes a sentence within a predetermined time period. The sentence must include the anger topic and a reason why the anger topic makes the player angry. If the player successfully verbalizes the sentence within the time limit he can then select a new letter card from the stack of letter cards. The winner of the game is the player who is able to use his letter cards in his hand to successfully spell a predetermined anger word or phrase. In a preferred embodiment, the anger phrase is “Pissed Off” and the winner is the player who is first able to successfully spell “Pissed Off” with his letter cards.

The present invention relates to card games, and in particular to card games for behavior training.

### BACKGROUND OF THE INVENTION

Anger is a difficult emotion for many people. As a society most of us are taught from an early age not to throw temper tantrums. People who are unable to project their anger in a socially acceptable manner are often frowned upon or worse. People who are just unable to properly express their anger often will then just repress their feelings of anger. This is unhealthy and can cause feelings of anxiety or even worse health consequences.

Repressed feelings of anger can be overwhelming and after a time can lead to destructive actions. Destructive actions can include hurtful, loud and unpleasant verbal outbursts. The destructive actions can also unfortunately include physical destruction and acts of violence towards property and even other people. People who are otherwise friendly and good can do harmful actions mainly because they never learned how to correctly express their anger.

In the prior art there are anger management courses and psychiatric counselors who can communicate with individuals with anger expression problems. Hopefully the individual can learn why he is angry and maybe adjust his behavior based on training and counseling that he receives. Medication can also be prescribed to individuals with anger management problems. Unfortunately the prior art methods of treating individuals with anger expression problems is expensive and often inaccessible to many with the problems.

What is needed is a better method for learning anger expression techniques.

### SUMMARY OF THE INVENTION

The present invention provides a method for playing a card game where players can practice expressing feelings of anger. A hand of letter cards is dwelt to players playing the game. A stack of topic cards is provided from which each player may draw. Each topic card includes an anger topic describing a situation commonly known to cause anger in the average person. A stack of letter cards is also provided. The player selects a topic card from the stack of topic cards. The player then verbalizes a sentence within a predetermined time period. The sentence must include the anger topic and a reason why the anger topic makes the player angry. If the player successfully verbalizes the sentence within the time limit he can then select a new letter card from the stack of letter cards. The winner of the game is the player who is able to use his letter cards in his hand to successfully spell a predetermined anger word or phrase. In a preferred embodiment, the anger phrase is “Pissed Off” and the winner is the player who is first able to successfully spell “Pissed Off” with his letter cards.

### BRIEF DESCRIPTION OF THE DRAWINGS

FIGS. 1-15 show preferred playing cards.

FIG. 16 shows a preferred deal to three players with a stack of topic cards and a stack of letter cards.

FIG. 17 shows a preferred hand.

FIG. 18 shows the preferred hand of FIG. 17 after it has been arranged.

FIG. 19 shows a preferred winning hand.

### DETAILED DESCRIPTION OF THE PREFERRED EMBODIMENTS

The present invention encourages players to express feelings of anger in a safe game setting amongst friends. The premise is that by practicing the expression of feelings of anger in a game situation, players will develop a skill for expressing real feelings of anger in a safe constructive manner in their daily lives. This is a very important skill to learn for many people who struggle with the challenge of constructively expressing their feelings of anger.

In the preferred embodiment each player competes to see who can be the first to spell out a predetermined target anger word or phrase with his letter cards. In the preferred embodiment described below the target anger phrase is “Pissed Off”. Each player is dwelt letter cards that contain letters that can be found in the target anger phrase “Pissed Off”. However, there is a very low probability that the dwelt hand will contain all the letters required to spell “Pissed Off”. To gain all the letters needed the player will have to verbalize sentences that express feelings of anger towards various anger topics. The various anger topics are written on topic cards. To play the game each player in turn draws a topic card and then reads the anger topic. Within a predetermined time limit, the player must verbalize a sentence that explains why the anger topic makes him angry. If he is successful the player then may draw a letter card in an attempt to have all the letter cards necessary to spell the target anger phrase “Pissed Off”. The winner of the game is the first player who has all the letters so that he can spell “Pissed Off”.

### A Preferred Embodiment of the Present Invention

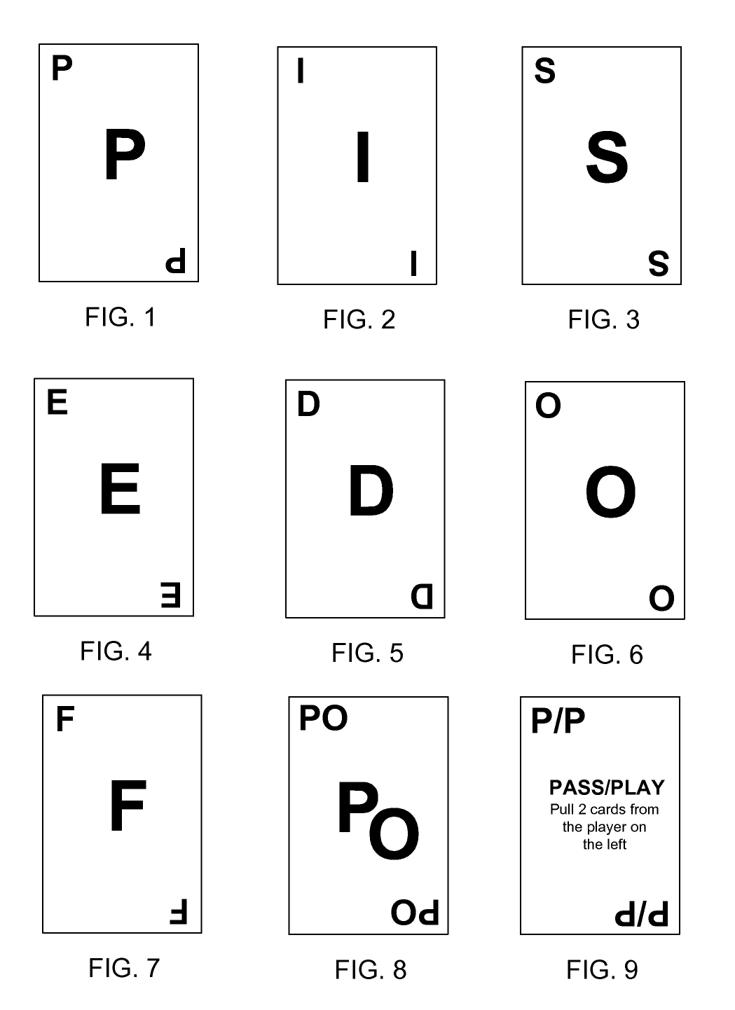

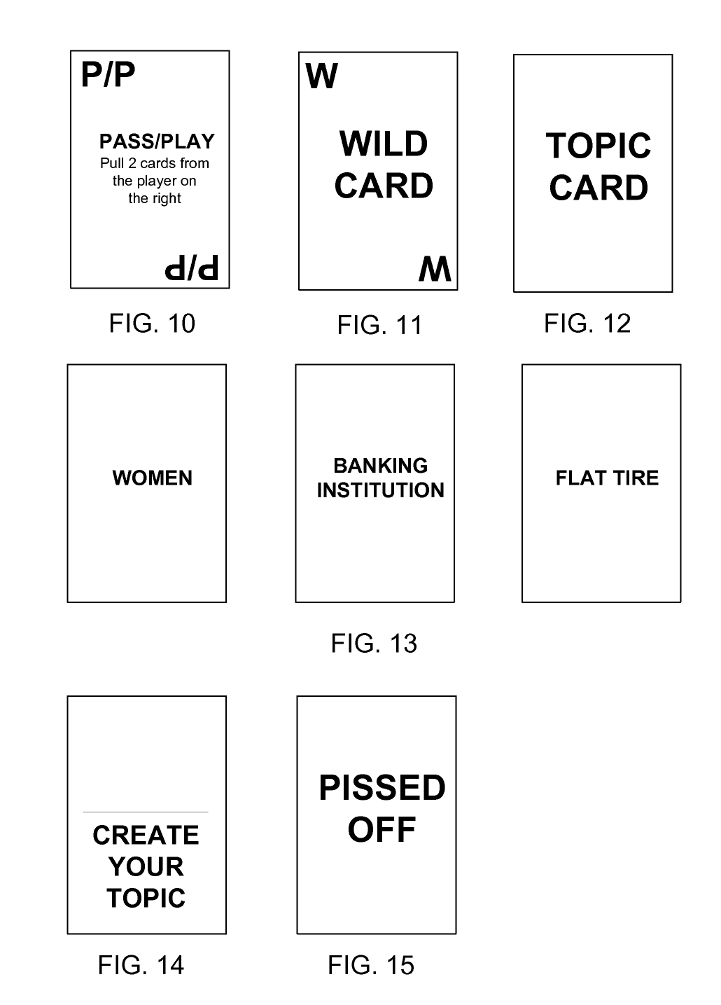

A preferred embodiment of the present invention includes two separate decks of cards (a letter card deck and a topic card deck). The letter card deck includes: 10 P cards (FIG. 1), 10 I cards (FIG. 2), 20 S cards (FIG. 3), 10 E cards (FIG. 4), 10 D cards (FIG. 5), 10 O cards (FIG. 6), 20 F cards (FIG. 7), 12 PO “Pissed Off” cards (FIG. 8), 5 Pass/Play to the left cards (FIG. 9), 5 Pass/Play to the right cards (FIG. 10), and 4 Wild cards (FIG. 11). FIG. 15 shows the back side of the first deck of cards. Preferably the words “Pissed Off” are written as shown on the back side of each card in the first deck as shown.

The topic card deck includes a total of 60 cards: 55 topic cards and 5 extra “Create Your Topic” cards. FIG. 12 shows the back side of the topic cards. FIG. 13 shows 3 of the 55 topic cards: a “Women” card, a “Banking Institution” card, a “Flat Tire” card. FIG. 14 shows a “Create Your Topic” card.

Each topic card includes a word or words that describe a subject that commonly is known to cause anger in the average person. Table 1 below is a list of the 55 preferred topics for the topic cards:

TABLE 1

| | |
|---|---|
| 1. | LIAR/S |
| 2. | DILEMMA/S |
| 3. | CELEBRITY/IES |
| 4. | RESTAURANT/S |
| 5. | PROFANITY |
| 6. | INFIDELITY |
| 7. | ALCOHOLIC/S |
| 8. | BED WETTING |
| 9. | DIVORCE |
| 10. | WORKPLACE |
| 11. | NARCISSISM |
| 12. | PEEPING TOM/S |
| 13. | MOTORISTS |
| 14. | LOVER/S |
| 15. | RUDE PEOPLE |
| 16. | WRONG ORDER |
| 17. | PAYDAY |
| 18. | ECONOMY |
| 19. | COMMUNICATION |
| 20. | PERVERT/S |
| 21. | SEX |
| 22. | FAMILY |
| 23. | SALES PEOPLE |
| 24. | DEBRIS |
| 25. | FATHER |
| 26. | MANICURIST |
| 27. | SISTER/S |
| 28. | FACETIOUSNESS |
| 29. | GOVERNMENT |
| 30. | HEALTH CARE |
| 31. | FLAT TIRE |
| 32. | SOLICITATOR/S |
| 33. | LAY-OFF/S |
| 34. | ADDICT/S |
| 35. | DIRECTIONS |
| 36. | BROTHER/S |
| 37. | ALARM/S |
| 38. | BUSY BODY/IES |
| 39. | MALE/PARTNER |
| 40. | DIET/S |
| 41. | UTILITIES |
| 42. | TELEMARKETER/S |
| 43. | POLITICIAN/S |
| 44. | FREEWAY/S |
| 45. | RELATIVE/S |
| 46. | SPOUSE |
| 47. | INQUISITIVENESS |
| 48. | WOMEN |
| 49. | EGO/S |
| 50. | BANKING INSTITUTION |
| 51. | COMPUTER/S |
| 52. | IN-LAWS |
| 53. | SPORTS |
| 54. | MEN |
| 55. | COMMERCIALS |

### A Preferred Method of Playing the Game

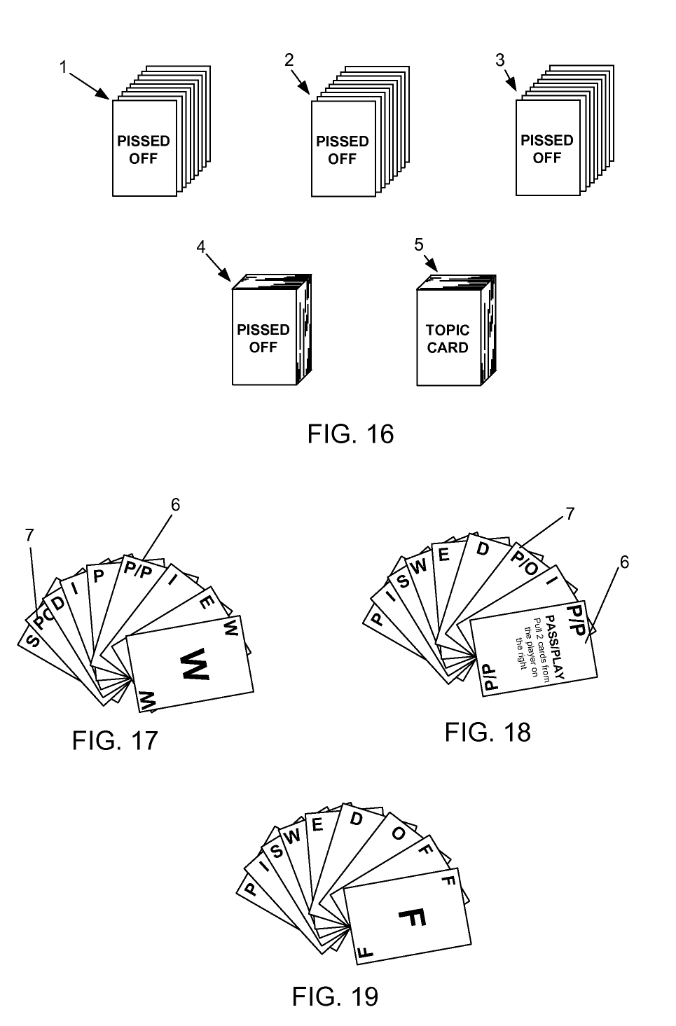

In a preferred embodiment of the present invention 2-6 players can play. FIG. 16 shows a preferred method of playing the game in which 3 players are playing the game. The dealer has dwelt 9 cards from a shuffled first deck to each player (the first player has been dwelt hand 1, the second player has been dwelt hand 2 and the third player has been dwelt hand 3). The 55 topic cards and 5 Create Your Topic cards have been placed in deck 5. The remainder of the letter cards is stacked in deck 4 adjacent to deck 5.

FIG. 17 shows the dwelt hand 1. To win the game each player tries to be the first one to spell the words “Pissed Off” with his cards. As shown in FIG. 17, Player 1 has some of the letters to spell “Pissed Off” but not all of them.

In FIG. 18 the first player has arranged the cards in his hand so that he can more clearly see what other cards he needs to spell “Pissed Off”. He has the letters “P”, “I”, and “S”. He has a wild card. The wild card can be used to take the place of any letter the player wants. In this case the first player wants to use the wild card to take the place of the second “S”. The first player also has the letters “E and “D”. By having a good deal, the first player already has the word “Pissed” spelled. However, he still needs the letters “O”, “F” and a second “F”.

In a fashion similar to that described above in reference to FIGS. 17 and 18, the second player and the third player also look at their dwelt cards and arrange them to determine what other letters are needed to spell “Pissed Off”.

After the hands are dwelt and the hands have been arranged, the player to the left of the dealer preferably goes first and then play continues clockwise. The first player draws a topic card from deck 5 and places the card face up. The player then has 5 seconds to give a complete sentence that utilizes the word that was shown on the topic card. In addition to the word on the topic card, the sentence also needs to include the words “Pissed Off” and the reason why the person was “Pissed Off”.

For example, in a preferred embodiment the player has flipped over a topic card that says “Flat Tire” (FIG. 13). He then has 5 seconds to state a sentence that satisfies the requirements described above. For example, a preferred sentence might be, “I am pissed off when I get a flat tire because I know that it is going to cost me money and time to get the tire fixed or replaced and I hate that!”

In a preferred embodiment, the player can use the actual words “Pissed Off” in a sentence or his sentence can state words that words that convey the same or similar meaning. For example, the player can state: “I get pissed off when . . . ” or “It really pisses me off when . . . ” or “I get angry when . . . ” or “I really get mad when . . . ” or “It makes my blood boil when . . . ” or “I really blow my top when . . . ”. The goal is for the player to practice using words to express his anger rather than physically acting out on his anger in a destructive manner.

If the player successfully creates a sentence in the 5 second window then he gets to pull a new letter card from deck 4 and discard an unwanted letter card.

If the player is unable to create a sentence in the 5 second window then he loses his turn.

### Create Your Topic Cards

If a player is dwelt or draws a Create Your Topic card then he can create his own topic and verbalize a sentence that includes that topic. The topic that the player creates can be one of the topics listed on the 55 topic cards, or he can make up his own new topic. For example, after drawing a Create Your Topic card, the player creates the topic of “Traffic”. His sentence he then states is, “Being in traffic really pisses me off because I need to be somewhere but instead I′m sitting in the middle of the freeway on a hot day breathing a bunch of car exhaust and it gives me a headache!”

### Pissed Off Cards

As shown in FIGS. 17 and 18, the first player has been dwelt a “Pissed Off” card 7 (see also FIG. 8). “Pissed Off” cards 7 are inactive cards and only take up space in the player's hand. Therefore they should be discarded by the player when possible.

### Pass/Play Cards

Prior to drawing a topic card, the player decides if he wants to use his Pass/Play card. For example, as shown in FIGS. 17 and 18, the first player has Pass/Play card 6.

As stated above, there are five Pass/Play cards that state “Pull 2 cards from the player on the left” and there are five Pass/Play cards that state “Pull 2 cards from the player on the right”. If a player wants to use the Pass/Play card he must show the card before his move. After announcing he wants to use his Pass/Play card, the player shows the Pass/Play card and then draws the top topic card from deck 5.

If the player correctly creates a sentence utilizing the word on the topic card (in a fashion similar to that described above) then he replaces his Pass/Play card 6 with a new letter card from deck 4. He then places his Pass/Play card into a discard stack. Additionally, he follows the directions on his Pass/Play card. For example if his Pass/Play card states “Pull 2 cards from the player on the left”, the player pulls two cards of his choice from the hand of the person to his left. The player then gives two of his unwanted cards to the player to the left.

If, however, the player is unable to create a sentence in the 5 second time limit, then the player does not interchange cards. Instead, he replaces his Pass/Play card 6 with a new letter card from deck 4. He then places his played Pass/Play card 6 into a discard stack.

As stated above, play continues as described until one of the players finally has all the correct cards to spell the words “Pissed Off”, as shown in FIG. 19. The first player to do so is the winner.

Although the above-preferred embodiments have been described with specificity, persons skilled in this art will recognize that many changes to the specific embodiments disclosed above could be made without departing from the spirit of the invention. For example, it was stated above that the target anger phrase is preferably “Pissed Off” and letters from the phrase “Pissed Off” are included in the letter cards. It should be recognized that it is possible to substitute the target anger phrase “Pissed Off” with virtually any other preferred target anger phrase or word. For example, in another preferred embodiment the target anger phrase is “It Makes Me Mad” and letters from the phrase “It Makes Me Mad” are included in the letter cards. Also, in another preferred embodiment the target anger word is “Angry” and letters from the word “Angry” are included in the letter cards. In another preferred embodiment the target anger phrase is “I Get Mad When” and letters from the phrase “I Get Mad When” are included in the letter cards. Therefore, the attached claims and their legal equivalents should determine the scope of the invention.

What is claimed is:

1. A method for playing a card game where the players of the card game practice expressing feelings of anger, said method comprising the steps of:
A. providing a hand of letter cards for each player playing the game,
B. providing a stack of topic cards for each player to draw from, wherein each topic card includes at least one anger topic describing situations commonly known to cause anger in the average person,
C. providing a stack of letter cards for each player to draw from,
D. selecting a topic card from said stack of topic cards,
E. verbalizing a sentence within a predetermined time limit that comprises:
i. said at least one anger topic,
ii. the reason why said at least one anger topic makes the player angry,
F. selecting a new letter card from said stack of letter cards if said sentence is successfully verbalized within said predetermined time limit,
G. spelling a predetermined target anger word or target anger phrase with said letter cards,
H. determining a player winner by determining which player first successfully spelled said predetermined anger word or phrase.

2. The method as in claim 1, wherein said letter cards further comprise at least one wild card.

3. The method as in claim 1, wherein said letter cards further comprise at least Pass/Play card.

4. The method as in claim 1, wherein said letter cards further comprise at least one Pissed Off card.

5. The method as in claim 4, wherein said Pissed Off card is an inactive card.

6. The method as in claim 1, wherein said stack of topic cards comprises at least on Create Your Topic card.

7. The method as in claim 1 wherein said target anger word is Pissed Off.
